(19) United States
(12) Patent Application Publication
(10) Pub. No.: US 2019/0178259 A1
(43) Pub. Date: Jun. 13, 2019

(54) VARIABLE RETURN CHANNEL VANES TO EXTEND THE OPERATING FLOW RANGE OF A VAPOR CYCLE CENTRIFUGAL COMPRESSOR

(71) Applicant: HONEYWELL INTERNATIONAL INC., MORRIS PLAINS, NJ (US)

(72) Inventors: Niall McCabe, Torrance, CA (US); Cassie Palo, Redondo Beach, CA (US); Michael Leighty, Westminster, CA (US); Brian Larsen, Downey, CA (US)

(73) Assignee: HONEYWELL INTERNATIONAL INC., MORRIS PLAINS, NJ (US)

(21) Appl. No.: 16/006,771

(22) Filed: Jun. 12, 2018

Related U.S. Application Data
(63) Continuation-in-part of application No. 15/889,962, filed on Feb. 6, 2018.
(60) Provisional application No. 62/597,927, filed on Dec. 12, 2017.

(51) Int. Cl. F04D 29/46; F04D 17/12; F04D 17/14; F25B 1/10

(52) U.S. Cl. CPC F04D 29/462; F04D 17/122; F04D 17/14; F05D 2210/42; F05D 2250/51; F05D 2240/12; F25B 1/10

(57) ABSTRACT

A vapor cycle compressor includes a controller section, a drive section in communication with the controller section, and a compression section operatively engaged with the drive section. The compression section includes a first compression stage and a return channel assembly downstream of the first compression stage. The return channel vane assembly includes return channel vanes that are configured to adjust their angle of orientation. The compression section also includes a second compression stage downstream of the return channel vane assembly, wherein inlet guide vanes are absent between the return channel vane assembly and the second compression stage.

### CROSS REFERENCE TO RELATED APPLICATIONS

This application claims the benefit of and priority to U.S. Ser. No. 15/889,962, filed Feb. 6, 2018 which claims the benefit of and priority to U.S. Ser. No. 62/597,927, filed Dec. 12, 2017, both of which are incorporated herein in their entirety.

### BACKGROUND OF THE INVENTION

The present invention generally relates to vapor cycle compressors and, more particularly, to apparatus and methods of widening the operational envelope of flows in centrifugal compressors.

Aircraft Vapor Cycle Environmental Control Systems need to operate over a wide range of environmental conditions—from cold days, to hot days. To accommodate these differing environmental requirements, the vapor cycle system (VCS) controls cooling by throttling the evaporator expansion valve while maintaining the difference between the VCS evaporator and condensing pressures. The closed loop nature of the VCS and the variable evaporator expansion valve leads to the vapor cycle compressor pressure ratios to remain high while the compressor flow decreases. The high pressure ratio with the wide mass flow range means that a wide flow compressor is required.

To achieve a wide flow range with a centrifugal compressor, the vapor cycle compressor must include variable geometry components. Typically, to achieve a wide flow range variable inlet guide vanes are used.

For most vapor cycle systems, the vapor cycle compressor is normally a multi-stage centrifugal compressor. A typical multi-stage compressor has a return channel vane and inlet guide vanes between the separate impeller and diffuser stages. The function of the return channel vane is to straighten the flow prior to it entering the next compressor stage. However, past designs of the return channel vanes and second stage inlet guide vanes have limited the operating flow range.

As can be seen, there is a need for improved apparatus and methods to increase the operational envelope in a centrifugal compressor.

### SUMMARY OF THE INVENTION

In one aspect of the present invention, a vapor cycle compressor comprises a controller section; a drive section in communication with the controller section; and a compression section operatively engaged with the drive section, wherein the compression section includes: a first stage compression section; a return channel assembly downstream of the first stage compression section; wherein the return channel vane assembly includes return channel vanes that are configured to adjust their angle of orientation; and a second stage compression section downstream of the return channel vane assembly; wherein inlet guide vanes are absent between the return channel vane assembly and the second stage compression section.

In another aspect of the present invention, a vapor cycle compressor comprises a controller section; a drive section in communication with the controller section; and a compression section operatively engaged with the drive section, wherein the compression section includes: a first stage inlet guide vane assembly; a first stage diffuser assembly downstream of the first stage inlet guide vane assembly; a variable return channel vane assembly downstream of the first stage diffuser assembly; and a second stage diffuser downstream of the variable return channel vane assembly; wherein second stage inlet guide vanes are absent between the variable return channel vane assembly and the second stage diffuser assembly.

In a further aspect of the present invention, a vapor cycle compressor comprises a controller section; a drive section in communication with the controller section; and a compression section operatively engaged with the drive section, wherein the compression section includes: a first stage inlet guide vane assembly; a first stage impeller assembly downstream of the first stage inlet guide vane assembly; a variable return channel vane assembly downstream of the first stage impeller; and a second stage impeller assembly downstream of the variable return channel vane assembly; wherein second stage inlet guide vanes are absent between the variable return channel vane assembly and the second stage impeller assembly.

These and other features, aspects and advantages of the present invention will become better understood with reference to the following drawings, description and claims.

### BRIEF DESCRIPTION OF THE DRAWINGS

FIG. 1A is a perspective view of an exterior of a vapor cycle compressor according to an embodiment of the present invention.

FIG. 1B is a perspective view of an interior of the vapor cycle compressor of FIG. 1A.

FIG. 2 is a conceptual diagram of a compression section of a vapor cycle compressor according to an embodiment of the present invention.

FIG. 3 is a cross sectional schematic view of a compression section of a vapor cycle compressor according to an embodiment of the present invention.

FIGS. 4A-4B are perspective views of a variable return channel vane assembly of a vapor cycle compressor according to an embodiment of the present invention.

FIG. 5 is a cross sectional view of a variable return channel vane assembly operatively engaged with a stepper motor assembly according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, the present invention provides a vapor cycle compressor that allows angle variation of return channel vanes and eliminates the need for second stage inlet guide vanes upstream of the second stage impeller. The present invention allows the return channel vanes to rotate about an axis through the vanes, which changes the flow angle of the fluid as it passes through the vanes. The addition of swirl to the flow helps increase flow range in the compressor.

The foregoing can provide a wider operational envelope, an improvement in the coefficient of performance, and the ability to use different refrigerants in the compressor without changing the design. This invention provides a hermetically sealed drive mechanism, redundancy for the drive mechanism, control logic that adjusts the vanes based on performance requirements, and weight reduction.

Although described in the exemplary context of an aircraft, the present invention can be used in other environments.

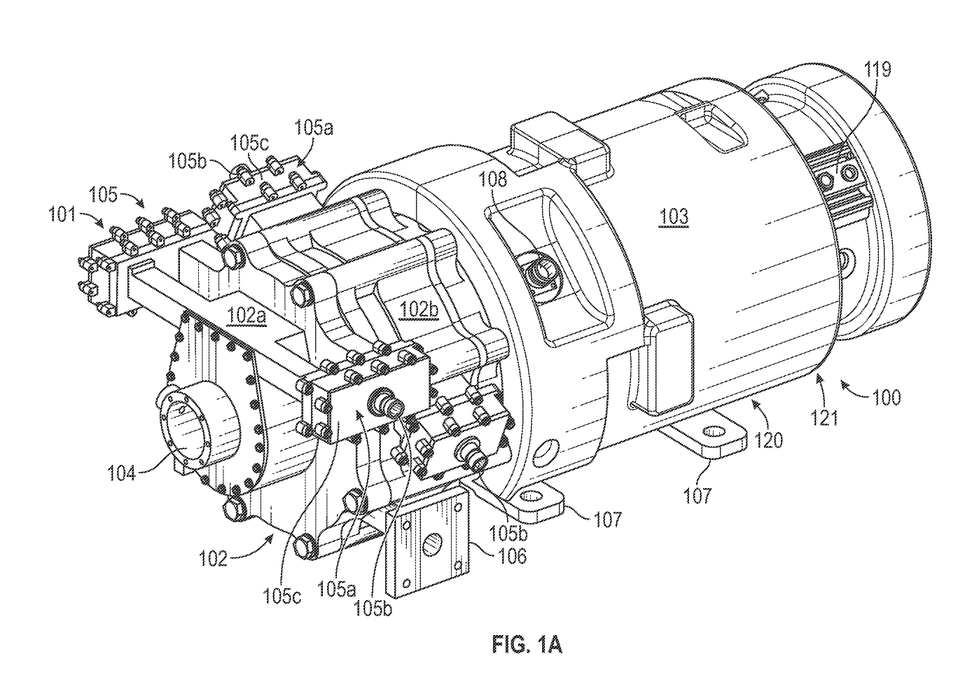

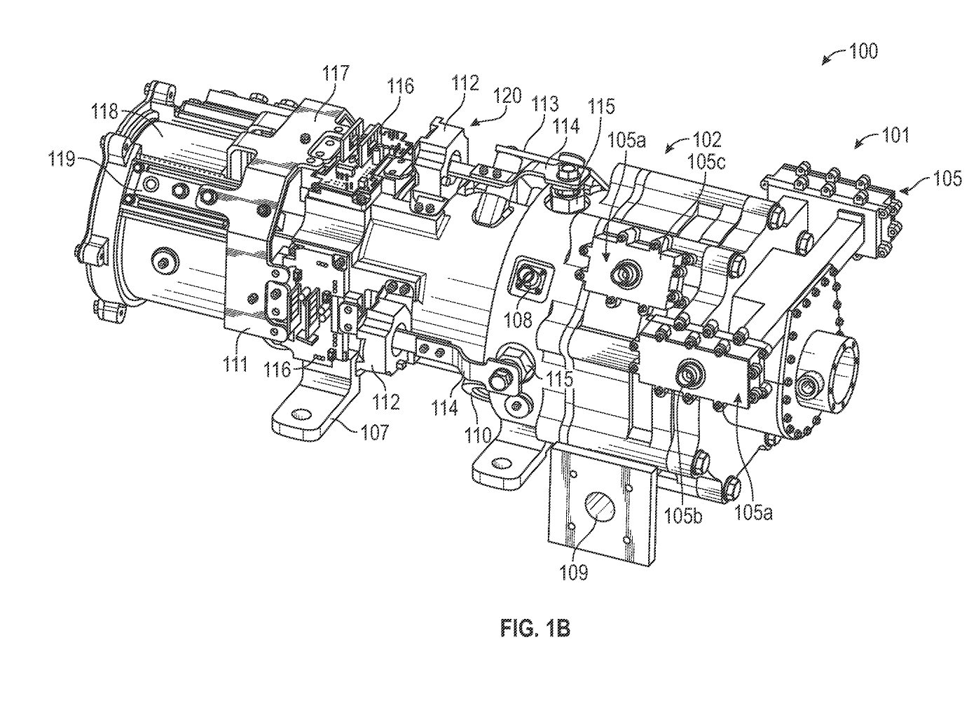

In FIG. 1A, an exemplary vapor cycle compressor 100 can be affixed to a support via mountings 107. The compressor 100 may include a drive section 101, a compression section 102 operatively engaged with the drive section 101, a controller section 120 in communication with the drive section 101, and a motor section 121 operatively engaged with the compressor section 102. The controller section 120 and the motor section 121 may be hermetically sealed in a cover/housing 103.

In embodiments, the drive section 101 may include a stepper motor assembly 105 that can be hermetically sealed. The stepper motor assembly 105 may be operatively engaged with an inlet guide vane assembly, and/or a first stage diffuser assembly, and/or a return channel assembly, and/or a second stage diffuser assembly, all of which can be part of the compression section 102 described below.

The stepper motor assembly 105 may include a plurality of stepper motor subassemblies 105a. One or more of the subassemblies 105a may include a stepper motor connector 105b and a stepper motor housing 105c. The stepper motor connector 105b may connect to power from a separate or internally derived source. One or more of the stepper motor subassemblies 105a may further include a stepper motor, a worm, a worm shaft, and a worm gear, as described below. Each stepper motor may be paired with and be operatively engaged to one or more of the inlet guide vane assembly, the first stage diffuser assembly, the second stage diffuser assembly, and the return channel assembly.

The compression section 102, according to embodiments, may include an inlet subsection 102a and an impeller/diffuser subsection 102b. The inlet subsection 102a may include a compressor inlet 104 configured to receive a vapor refrigerant. The inlet subsection 102a may further include an inlet guide vane assembly described below.

The impeller/diffuser subsection 102b, in embodiments, may include an upstream first stage impeller assembly, a downstream first stage diffuser assembly, a downstream variable return channel assembly, a downstream second stage impeller assembly, and a downstream second stage diffuser assembly described below. The impeller/diffuser subsection 102b may also include a sub-cooling inlet 106 that is configured to increase cooling performance and extend compressor flow range.

In FIG. 1B, according to embodiments, the controller section 120 of the compressor 100 may include a digital signal processor 113 that is configured to provide localized compressor torque and speed control which includes stepper motor function, and a high power switch module 116 that is configured to provide control of the main electric motor 121. A current sensor transducer 112 can be configured to measure power into the motor section 121, a motor bus bar 114 can be configured to distribute current, and a stud seal terminal 115 can be configured to pass electric current from the exterior of the compressor to the interior of the compressor. A capacitor 118 can be configured to maintain constant controller DC link voltage, capacitor bus bar 117 can be configured to supply or distribute link voltage, and a power input terminal 119 can be configured to receive power to the compressor. Also provided are a controller data connection port 108, a cooling sleeve outlet port 110, a DC link buss bar (controller component) 111, and a gate driver board (controller component) 116.

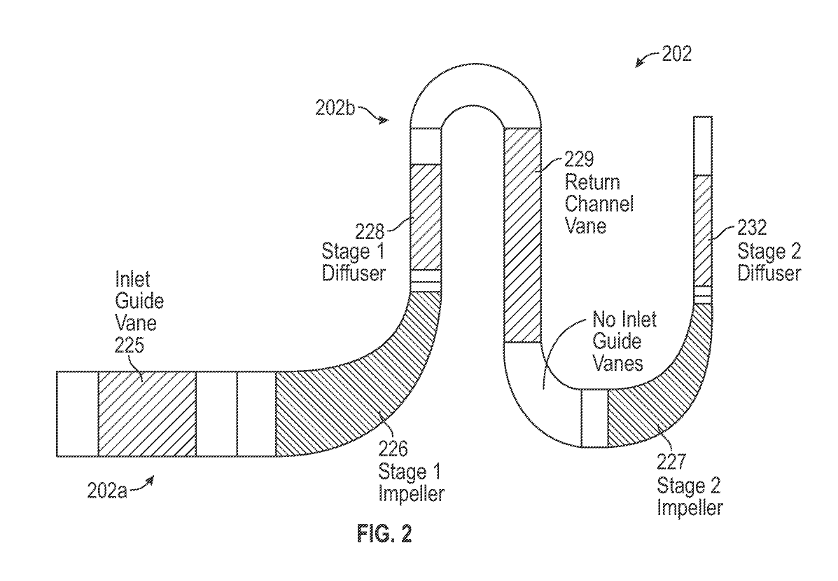

In FIG. 2, according to embodiments, a compression section 202 may include an inlet subsection 202a and an impeller/diffuser subsection 202b, all of which can be similar to that described in relation to FIGS. 1A-1B. Accordingly, reference numbers in FIG. 2 correspond to like reference numbers in FIGS. 1A-1B.

The inlet subsection 202a may include an inlet guide vane assembly 225. The impeller/diffuser subsection 202b may include a first stage impeller assembly 226, a first stage diffuser assembly 228, a variable return channel assembly 229, a second stage impeller assembly 227, and a second stage diffuser assembly 232.

Notably absent from the compression section 202 and, in particular, from the impeller/diffuser subsection 202b, is a second stage inlet guide vane assembly which might otherwise be present between the return channel vane assembly 229 and the second stage impeller assembly 227. The use of second stage inlet guide vanes is shown, for example, in U.S. Pat. No. 2,300,766. In contrast, the present invention eliminates the need for second stage inlet guide vanes by the use of variable return channel vanes described below. This can result in weight reduction of the vapor compressor.

As further described in U.S. Ser. No. 15/889,962 (which is incorporated herein by reference), the motor section may, in embodiments, include a motor (not shown) that can have a stator (not shown) and a rotor (not shown). A tie rod (not shown) may extend from within the motor, through a thrust bearing disk (not shown), and into the compression section. Thereby, the motor section may drive the first stage and second stage impeller assemblies of the compression section. In so doing, a vapor refrigerant may be compressed while flowing in a vapor refrigerant path through the inlet guide vane assembly, then through the first stage impeller assembly, then through the first stage diffuser assembly, then through the variable return channel assembly, then through the second stage impeller assembly, and then through the second stage diffuser assembly.

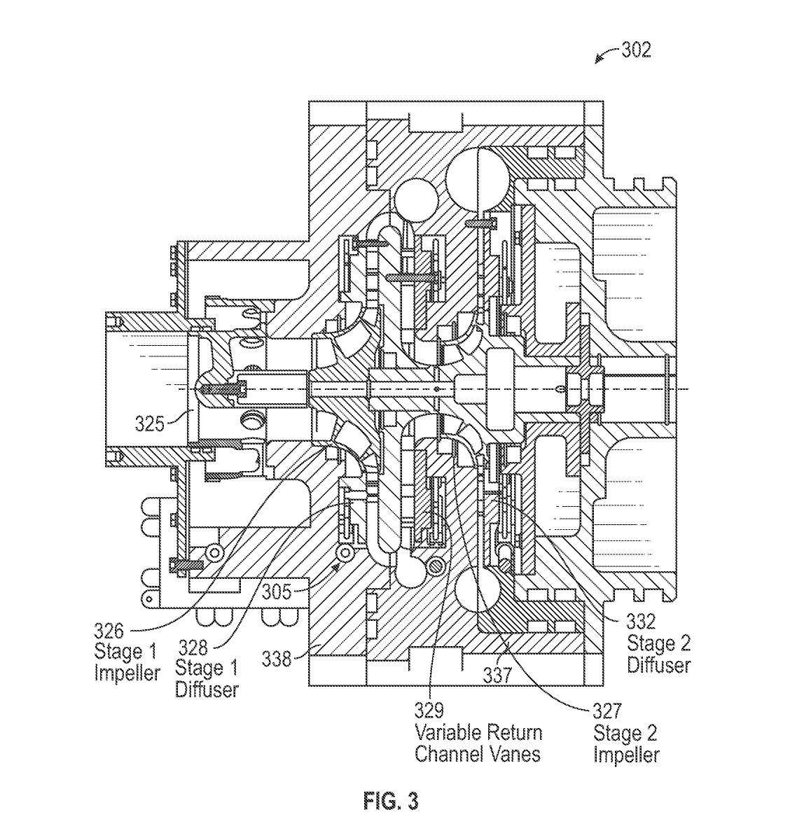

In FIG. 3, a compression section 302 and a stepper motor assembly 305, according to embodiments, are shown. The compression section 302 may be similar to that described in relation to FIGS. 1A-1B and 2. Accordingly, reference numbers in FIG. 3 correspond to like reference numbers in FIGS. 1A-1B and 2.

The compression section 302 may include an inlet guide vane assembly 325 that can receive vapor refrigerant. From there, vapor refrigerant may be compressed in two stages. A first compression stage may include a first stage impeller assembly 326 directly downstream of the inlet guide vane assembly 325. Also in the first compression stage, a first stage diffuser assembly 328 may be directly downstream of the first stage impeller assembly 326.

The first compression stage and the inlet guide vane assembly 325 may be within a housing 338. The housing 338 may further enclose the stepper motor assembly 305 to provide hermetic sealing of the compression section 302 and the stepper motor assembly 305.

In embodiments, the compression section 302 may include a variable return channel assembly 329 (having variable return channel guide vanes described below), directly downstream of the first stage diffuser assembly 328, and that may direct vapor refrigerant directly from the first compression stage and into the second compression stage. In other words, vapor refrigerant may flow from the first compression stage to the second compression stage in the absence of vapor refrigerant having to flow through inlet guide vanes between the first and second compression stages.

The second compression stage may include a second stage impeller assembly 327 directly downstream of the return channel assembly 329—with no inlet guide vanes therebetween. In the second compression stage, a second stage diffuser assembly 332 may be directly downstream of the second stage impeller assembly 327. The second compression stage may be within a housing 337 for hermetic sealing.

In the compression section 302, according to embodiments, an inlet (not shown) may provide vapor refrigerant to an inlet scroll (not shown) that can be configured to provide additional flow to the second stage, while an outlet scroll (not shown) may be configured to direct vapor refrigerant out of the second compression stage, via an outlet (not shown). The inlet and outlet scrolls may be within the housing 337. A housing (not shown) may enclose a thrust disk (not shown).

Still referring to FIG. 3, the stepper motor assembly 305 may be similar to that described in relation to FIGS. 1A-1B and 2. Accordingly, reference numbers in FIG. 3 correspond to like reference numbers in FIGS. 1A-1B and 2.

According to embodiments, the stepper motor assembly 305 may include a plurality of stepper motor subassemblies. A respective stepper motor subassembly may be operatively engaged to at least the return channel assembly 329 and optionally to one or more of the inlet guide vane assembly 325, the first stage diffuser assembly 328, and the second stage diffuser assembly 332 as described below.

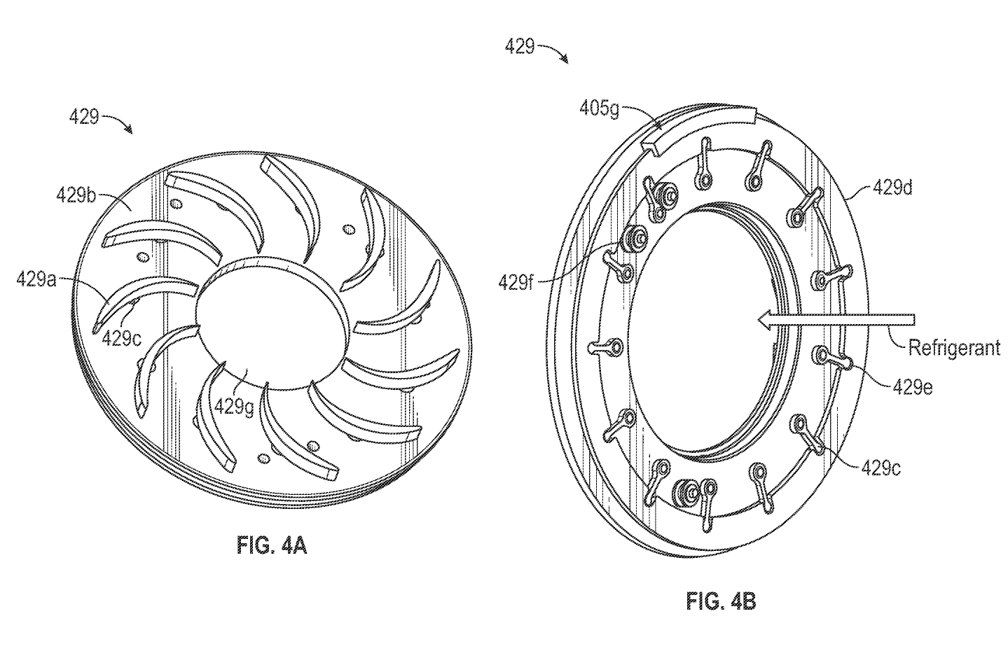

FIGS. 4A-4B depict an exemplary variable return channel vane assembly 429. The return channel vane assembly 429 may be similar to that described in relation to FIGS. 2 and 3. Accordingly, reference numbers in FIGS. 4A-4B correspond to like reference numbers in FIGS. 2 and 3.

According to embodiments, the return channel vane assembly 429 may be configured to receive a vapor refrigerant flow, which can be, for example, from a first compression stage and, in particular, a first stage impeller assembly. The return channel vane assembly 429 may include a plurality or set of downstream variable vanes 429a that receives the refrigerant flow.

The set of return vanes 429a, and each individual return vane 429a in such set, can be characterized by an angle of orientation. The angle of orientation may be measured by an angle about which each return vane may rotate around an axis of rotation. The axis of rotation may be substantially parallel to a longitudinally extending tie rod, described above, which can extend through an aperture 429g. As described below, the angle of orientation may be adjusted or varied.

In embodiments, the return channel vane assembly 429 may further include a return plate 429b that can support on one planar side thereof, via connectors 429c, the return vanes 429a. On an opposed planar side of the return vane assembly 429, a unison ring 429d may be operatively engaged to one or more driver arms 429e. The unison ring 429d may also be operatively engaged to one or more worm gears 405g. One or more rollers 429f may rotatably support the unison ring 429d at an inner circumference thereof.

With the above, the variable return channel vanes 429a can rotate about an axis through the vane and change the flow angle of the fluid through the vane and received by the next stage of the compressor. The addition of swirl to the flow helps increase flow range in the compressor.

For an inlet guide vane to turn the fluid flow through the vane to an angle “x”, the vane must rotate the same angle value “x”. The variable return channel vanes of the present invention allow the fluid flow through the vane to turn the fluid to an angle “x”, by rotating the vane by an angle less than “x”. As an example, with the variable return channel vanes of the present invention, inlet swirl angles of 49 degrees were achieved by turning the return channel vane through an angle of 20 degrees. The ability to turn the fluid flow 49 degrees while only turning the vane 20 degrees allows the actuation mechanism to be simpler as the amount the vane needs to turn can be reduced by a factor of 2.

Although FIGS. 4A-4B depict an exemplary return channel vane assembly, it should be understood that similar components and the assembly thereof can also be used for one or more of the first stage inlet guide vanes, the first stage diffuser assembly, and the second stage diffuser assembly, such as that depicted in FIGS. 2 and 3.

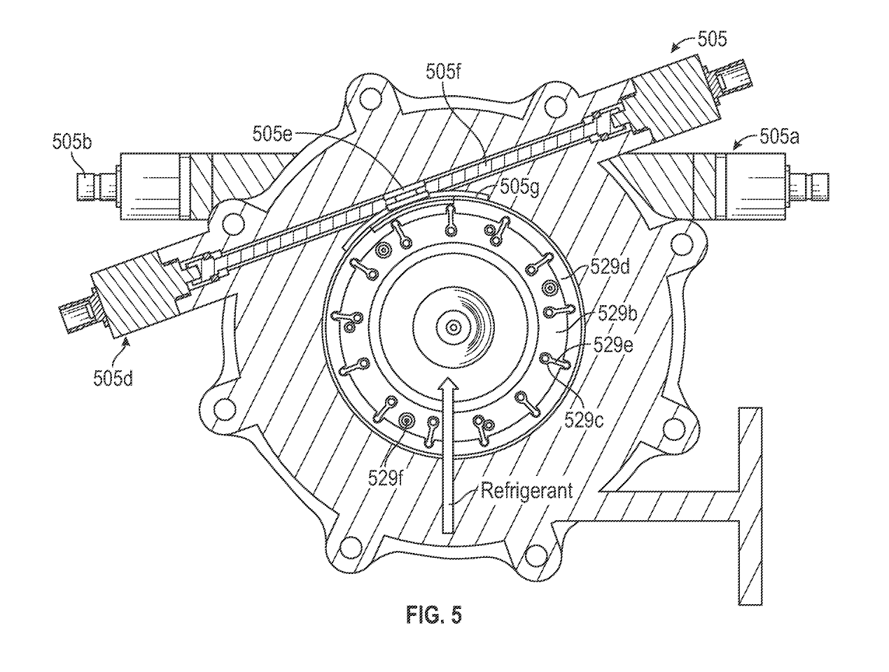

FIG. 5 depicts an exemplary stepper motor assembly 505 operatively engaged to a plurality or set of variable return channel vanes, such as those that may be included in a return channel assembly, as described above with regard to FIGS. 2, 3, and 4A-B. Accordingly, reference numbers in FIG. 5 correspond to like reference numbers in FIGS. 2, 3 and 4A-B.

The stepper motor assembly 505 may include one or more stepper motor subassemblies 505a. One or more of the stepper motor subassemblies 505a may include one or a pair of redundant stepper motors 505d connected by a worm shaft 505f there between. Accordingly, if one of the paired stepper motors 505d fails, the other of the paired motors may be used. A stepper motor connector 505b may be provided at each stepper motor 505d to provide power.

In embodiments, one or more of the stepper motor subassemblies 505a may include at least one worm 505e that is operatively engaged to at least one worm gear 505g which, in turn, can be operatively engaged to the set of variable return vanes (not shown).

The variable return vanes can be supported by a plate 529b. The plate 529b may support one or more driver arms 529e that can be operatively engaged, via one or more connectors 529c, to one or more of the variable vanes. Also, one or more of the driver arms 529e may be operatively engaged to a unison ring 529d. One or more rollers 529f may support the ring 529d.

In operation, a single stepper motor 505d, or one of the paired stepper motors 505d, may rotate the worm shaft 505f. In turn, the worm 505e may rotate, which can cause the worm gear 505g to rotate. The rotation of the worm gear 505g causes the unison ring 529d to rotate. In turn, one or more of the driver arms 529e can rotate. Via the connector 529c associated with the rotating arms 529e, one or more of the vanes rotate about a longitudinal axis of the connector 529c.

It can be appreciated that the stepper motor assembly, upon control from the controller section, can rotate one or more of the sets of variable vanes of the inlet guide vane assembly, the first stage diffuser assembly, the return channel assembly, and the second stage diffuser assembly.

It should be understood, of course, that the foregoing relates to exemplary embodiments of the invention and that modifications may be made without departing from the spirit and scope of the invention as set forth in the following claims.

We claim:

1. A vapor cycle compressor, comprising:
a controller section;
a drive section in communication with the controller section; and
a compression section operatively engaged with the drive section, wherein the compression section includes:
a first compression stage;
a return channel assembly downstream of the first stage compression section;
wherein the return channel vane assembly includes return channel vanes that are configured to adjust their angle of orientation; and
a second compression stage downstream of the return channel vane assembly;
wherein inlet guide vanes are absent between the return channel vane assembly and the second compression stage.

2. The compressor of claim 1, further comprising a stepper motor assembly operatively engaged with the return channel assembly.

3. The compressor of claim 1, wherein the first compression stage includes a first stage impeller assembly and a first stage diffuser assembly.

4. The compressor of claim 1, wherein the second compression stage includes a second stage impeller assembly and a second stage diffuser assembly.

5. The compressor of claim 1, wherein the first compression stage includes variable vanes.

6. The compressor of claim 1, wherein the second compression stage includes variable vanes.

7. The compressor of claim 1, further comprising a stepper motor assembly operatively engaged to at least one of the first compression stage and the second compression stage.

8. A vapor cycle compressor, comprising:
a controller section;
a drive section in communication with the controller section; and
a compression section operatively engaged with the drive section, wherein the compression section includes:
a first stage inlet guide vane assembly;
a first stage diffuser assembly downstream of the first stage inlet guide vane assembly;
a variable return channel vane assembly downstream of the first stage diffuser assembly; and
a second stage diffuser downstream of the variable return channel vane assembly;
wherein second stage inlet guide vanes are absent between the variable return channel vane assembly and the second stage diffuser assembly.

9. The compressor of claim 8, wherein the first stage inlet guide vane assembly includes a plurality of inlet vanes, at least one of which has an angle of orientation that is adjustable.

10. The compressor of claim 8, wherein the first stage diffuser assembly includes a plurality of first diffuser vanes, at least one of which has an angle of orientation that is adjustable.

11. The compressor of claim 8, wherein the return channel assembly includes a plurality of return channel vanes, at least one of which has an angle of orientation that is adjustable.

12. The compressor of claim 8, wherein the second stage diffuser assembly includes a plurality of second diffuser vanes, at least one of which has an angle of orientation that is adjustable.

13. The compressor of claim 8, wherein the drive section is hermetically sealed.

14. The compressor of claim 8, wherein the compression section is hermetically sealed.

15. A vapor cycle compressor, comprising:
a controller section;
a drive section in communication with the controller section; and
a compression section operatively engaged with the drive section, wherein the compression section includes:
a first stage inlet guide vane assembly;
a first stage impeller assembly downstream of the first stage inlet guide vane assembly;
a variable return channel vane assembly downstream of the first stage impeller; and
a second stage impeller assembly downstream of the variable return channel vane assembly;
wherein second stage inlet guide vanes are absent between the variable return channel vane assembly and the second stage impeller assembly.

16. The compressor of claim 15, wherein the drive section includes a stepper motor assembly operatively engaged with vanes of the return channel vane assembly.

17. The compressor of claim 15, wherein the drive section is hermetically sealed.

18. The compressor of claim 15, wherein the controller section is hermetically sealed.

19. The compressor of claim 15, wherein the return channel vane assembly includes:
a unison ring operatively engaged to the drive section;
a plurality of driver arms operatively engaged with the unison ring and with the vanes;
wherein, when the drive section is activated, the plurality of driver arms activate the vanes.

20. The compressor of claim 15, wherein:
the drive section includes a stepper motor assembly;
wherein the stepper motor assembly includes at least one pair of stepper motors;
wherein the at least one pair of stepper motors is operatively engaged to the return channel vane assembly.
